(19) United States
(12) Patent Application Publication
(10) Pub. No.: US 2004/0066748 A1
(43) Pub. Date: Apr. 8, 2004

(54) Method and apparatus for testing a data network

(76) Inventor: Charles James Burnett, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/264,727

(22) Filed: Oct. 4, 2002

(51) Int. Cl. H04J 1/16; H04L 12/28

(52) U.S. Cl. 370/241.1; 370/395.1

(57) ABSTRACT

A method of testing a network comprises the steps of parsing a cell from the network and obtaining network performance data based upon the cell. The method calls for evaluating a condition of a live memory flag and storing the network performance data in a first memory if the live memory flag reflects an affirmative value and storing the network performance data in a second memory element if the live memory flag reflects a negative value. The steps of parsing, obtaining, evaluating, and storing are repeated to test the network at speed. Advantageously, a method according to the teachings of the present invention permits at-speed collection, calculation, and storage of network performance data as well as capturing a coherent set of statistic at desired intervals. The method disclosed herein is well suited to testing ATM networks.

### BACKGROUND

Data networking is a powerful tool in current communication systems. As data networking has matured and become more prevalent over the years, data protocol complexities and data rates have increased. Asynchronous Transfer Mode (ATM) networks are one of the prevalent data communication protocols in use. ATM is a cell-relay technology that divides upper-level data units into 53-byte cells for transmission over the physical medium. It operates independently of the type of transmission being generated at the upper layers and of the type and speed of the physical-layer medium below it. The ATM technology permits transport of transmissions (e.g, data, voice, video, etc.) in a single integrated data stream over any medium, ranging from existing T1/E1 lines to SONET OC-3 at speeds of 155 Mbps. The basic standards that define ATM are ITU-T 1.361 which defines the ATM Layer functions, ITU-T 1.363 that defines the ATM Adaptation Layer protocols, and ITU-T 1.610 which defines the ATM Operation and Maintenance (OAM) functions.

In order to maintain an ATM data network, it is helpful to have the ability to detect and diagnose problems while the network is running at-speed and without having to disable data communication traffic. A tool that aids in the detection and diagnosis of data communication troubles is the collection and statistical processing of information relating to data traffic over the network. As one of ordinary skill in the art appreciates, collection of raw data is of minimal value without some additional processing of the raw data into information that may be interpreted by a test operator. Data networking statistics help reduce the raw data to information by providing information to a test operator concerning the patterns of data flow.

There are a number of different statistics that an operator may want to collect for an ATM network depending upon the problems experienced by the network at any given time. Additionally, it is beneficial to obtain the statistics on a per channel basis. The ATM protocol has the capability of processing over 256,000,000 streams at a time. A stream is used herein to mean an individual communication between two entities on the network. Each stream is transferred in a plurality of cells over the ATM network. Each cell comprises 5 bytes of header and 48 bytes of payload. The ATM cells are transferred sequentially and may be interleaved with cells from different streams. It is the job of the ATM switch to interpret a header of each cell, determine to which stream the cell is destined, and route the cell accordingly.

To properly test an ATM network, there is a need to collect and calculate performance data for each ATM stream while the network is running at-speed. As one of ordinary skill in the art can appreciate, a plurality of different performance datum for a number of streams requires that a network test device be capable of collecting, calculating and storing a large quantity of different numbers. Significantly, it is optimum for all performance data to be coherent with each other. That is to say that it is best when a data relating to one stream is valid for the same point in time as data relating to a different stream. This can present a challenge when reading stored network performance data for display on the test device. Because the testing is performed at-speed, more data is collected, calculated, and stored while the previously stored data are being read from memory and displayed on a display of the test device. If data is being stored and retrieved simultaneously, then the data read from a beginning portion of memory will apply to a different point in time that the data read from an ending portion of memory. In this case, one datum does not properly correlate in time to other data. Alternatively, it is possible to suspend the collection of data as the data are being retrieved from memory. In this solution, however, some network data is lost and the data do not accurately reflect the activity of the network.

Accordingly, there is a need for a network test device to obtain a coherent grouping of data for multiple streams while continuing to test the network at-speed.

### SUMMARY

A method of testing a network comprises the steps of parsing a cell from the network and obtaining network performance data based upon the cell. The method calls for evaluating a condition of a live memory flag and storing the network performance data in a first memory element if the live memory flag reflects an affirmative value and storing the network performance data in a second memory element if the live memory flag reflects a negative value. The steps of parsing, obtaining, evaluating, and storing are repeated to test the network at speed.

According to another aspect of the invention, an apparatus for testing a network comprises means for parsing a cell on the network and means for obtaining network performance data based upon the cell. The apparatus also comprises a live memory flag storage element and means for evaluating a condition of the live memory flag storage element. A first memory receives the network performance data if the live memory flag storage element has an affirmative value and a second memory receives the network performance data if the live memory flag storage element has a negative value.

According to another aspect of a method of testing a network according to the teachings of the present invention a process eavesdrops onto the network and parses a cell. The cell yields network performance data upon which statistics are calculated. The process toggles a live memory flag at regular intervals of time. Also at regular intervals of time, a condition of the live memory flag is evaluated and if it is affirmative, the statistics are stored in an A memory element. If the live memory flag reflects a negative value, the statistics are stored in a B memory element. The process retrieves the statistics at the regular intervals of time, and repeats said steps of parsing, obtaining, calculating, evaluating, storing, and retrieving.

Advantageously, a method and apparatus according to the teachings of the present invention permit at-speed collection, calculation, and storage of network performance data as well as capturing a coherent set of the network performance data at desired intervals of time. The method and apparatus disclosed herein is well-suited to testing networks that benefit from analysis of performance on a per stream basis, specifically ATM and TCP networks.

### BRIEF DESCRIPTION OF THE DRAWINGS

FIG. 1 is an illustration of an ATM data network.

FIG. 2 is a conceptual illustration of ATM network data stream.

FIG. 3 is a block diagram of an embodiment of a test device according to the teachings of the present invention.

FIG. 4 is a block diagram of a line interface module portion of a test device according to the teachings of the present invention.

FIG. 5 is a conceptual illustration of the relationship between the first and second memory elements for storing network statistics.

FIGS. 6 through 9 are flow charts of embodiments of data storage process according to the teachings of the present invention.

FIG. 10 is a flow chart of an embodiment of the data retrieval process according to the teachings of the present invention.

FIG. 11 is a flow chart of an embodiment of a synchronization process used in a system according to the teachings of the present invention.

### DETAILED DESCRIPTION

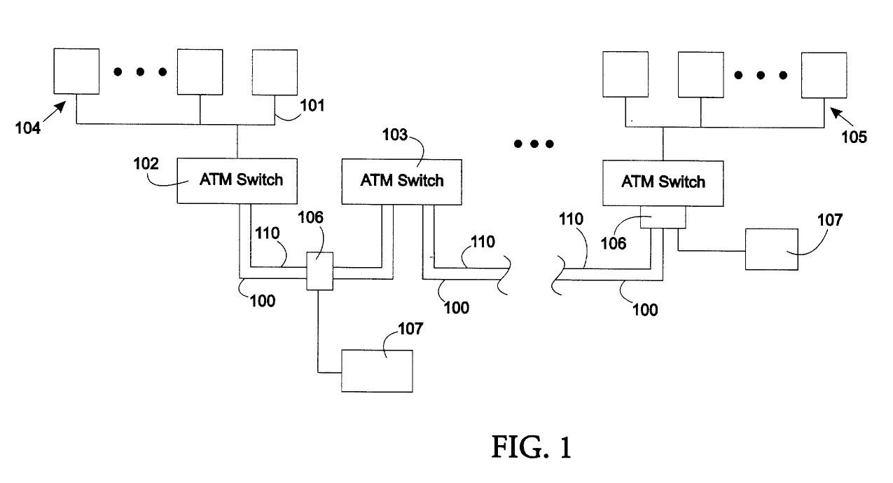

With specific reference to FIG. 1 of the drawings, there is shown an illustration of a representative ATM data network. An ATM network comprises one or more physical cables 100, 110 between first and second ATM switches 102, 103. The physical cables 100, 110 carry electrical or optical data signals to and from the ATM data switches 102, 103. The conventional ATM network is typically a full duplex system that has two dedicated cables, one each for the reception 100 and transmission 110. The ATM data switches are often connected to a local network. The ATM switches 102 or 103 act as the interface between the ATM network and the local network. The ATM data switch 102 or 103 performs segmentation of data from an origination local network 104 into 53 byte cells for transmission across the ATM network. When the cell reaches a destination ATM switch 103 or 102, the ATM switch 103 or 102 either transmits the cell to a next ATM switch in the circuit or performs reassembly of the cells for presentation to a destination local network 105. As a practical matter, there are typically on the order of hundreds of streams that are active at any one time on a single ATM network. Other streams are inactive and eventually timeout and become irrelevant. Accordingly, as some streams are in the process of timing out, there are on the order of 1500-2000 streams that must be tracked at any one point in time. With this in mind, it is assumed that a test device that is able to track an upper limit of 4096 active streams will be able to adequately handle a worst-case scenario. One of ordinary skill in the art appreciates that ATM networks will get faster and be able to accommodate a greater number of streams as technology progresses. Accordingly, the teachings of the present invention may be scaled to accommodate more than the 4096 streams as network and processing capabilities increase.

In order to test an ATM network, a test device probe 106 plugs into the ATM network at any point along its length, either at the cables 100, 110 with a tap or at one or more of the ATM switches 102, 103. The probe 106 eavesdrops onto the data traffic without interfering with transmission of the data on the ATM network in any way. Advantageously, the ATM network may operate at speed and without any accommodation made for the presence of the probe 106. The probe 106 communicates with a test device 107 that receives and processes the data present on the ATM network.

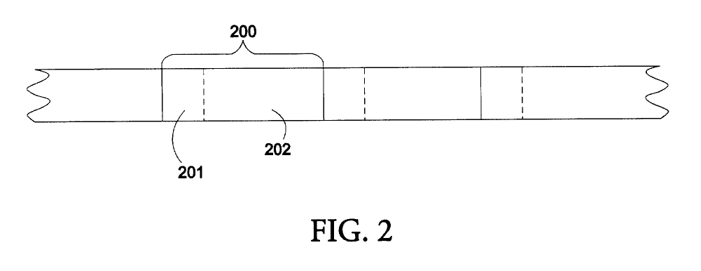

With specific reference to FIG. 2 of the drawings, there is shown a representation of multiple cells 200 present on the ATM network. Each cell 200 comprises 53 bytes of information. There are 5 bytes in a header 201 and 48 bytes of payload 202. Each cell is part of a unique stream of information and multiple cells make up a single stream. Additionally, there are operations and maintenance (OAM) cells used to provide various maintenance functions within the ATM network, including connectivity verification and alarm surveillance. Operation and maintenance cells (OAM cells) and resource management cells (RM cells) are 53 bytes, but have different structures than the data cells. A stream represents a communication from a source device, such as a computer, to a destination device. ATM cells that make up each unique stream may be transmitted at different rates. The cells 200 that comprise the stream are sent sequentially, but may be sent at any rate and are typically interleaved with other cells from different streams as well as the OAM and RM cells. Certain streams may transmit cells at a higher rate than other streams and it is not possible to predict an interleave pattern on the network. Accordingly, in order to reassemble cells into a stream, it is necessary to parse and interpret the header information in each cell before appropriately disposing of the payload.

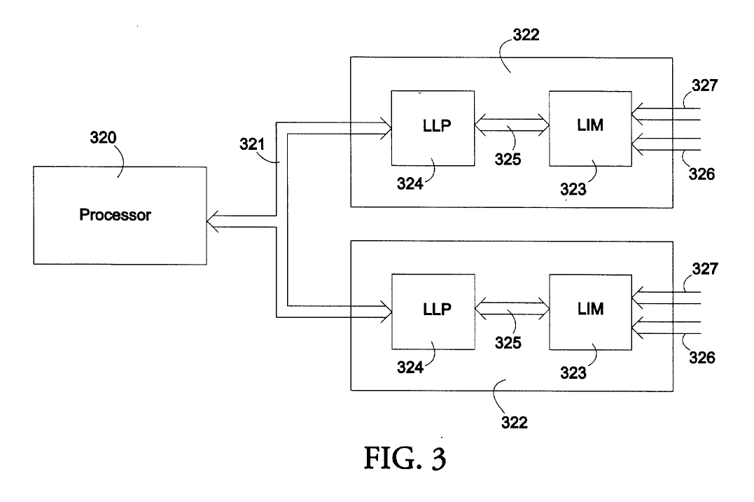

With specific reference to FIG. 3 of the drawings, a test device 107 according to the teachings of the present invention comprises a processor such as a personal computer 320 or equivalent communicating over a communications bus 321 to one or more electronic printed circuit boards (“PCB”) 322. In the embodiment illustrated, the processor 320 and PCBs 322 share a chassis and power supply. The illustration shows two PCBs, however, the number of PCBs is dictated by a user's need and limited by a physical capacity of the chassis. In an alternate embodiment, the internal communications bus may be an external LAN where the processor 320 is remote from the other hardware elements. Referring back to FIG. 3 of the drawings, each printed circuit board 322 contains a line interface module (“LIM”) 323 and a link layer processor (“LLP”) 324. The LIM and the LLP communicate over an internal communications bus 325. The circuitry on each of the PCBs is the same, therefore, only the structure of one PCB is further described. The PCB 322 has two channels. A first channel 326 is connected to the cable 100 carrying incoming cells 200 and a second channel is connected to the cable 110 carrying outgoing data 327. In a specific embodiment, there are different PCBs 322 for connections to different types of ATM networks. As an example, a PCB for connection to an optical ATM network has a different configuration and physical connector than that for a connection to an electrical network. The logic contained in the PCBs, however, remains the same.

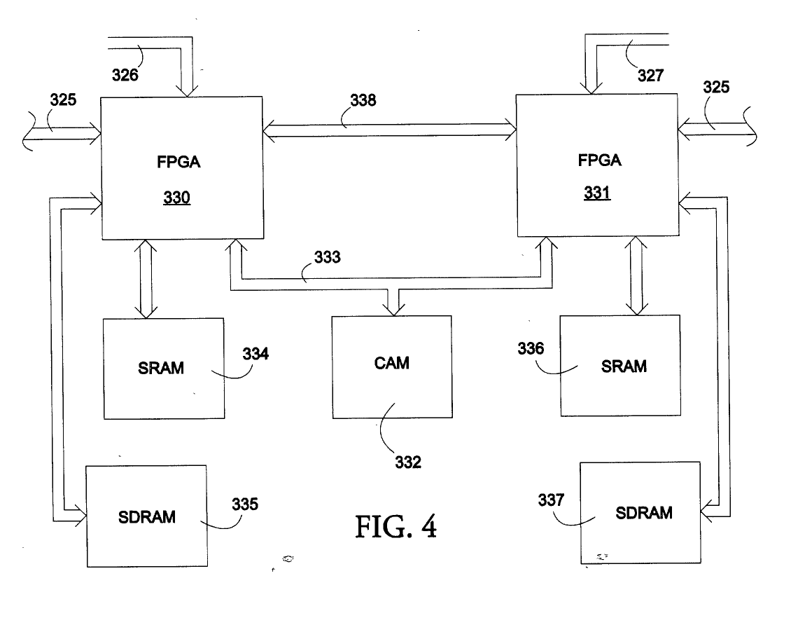

With specific reference to FIG. 4 of the drawings, there is shown a block diagram for the line interface module (“LIM”) 323 present on the PCB 322. The LIM comprises first and second field programmable gate arrays (“FPGAs”), 330 and 331 respectively, that receive the data from the first and second channels 326, 327. The FPGAs are both connected to a single content addressable memory (“CAM”) 332 over a shared CAM bus 333. The first FPGA 330 is also connected to a dedicated first SRAM 334 and first SDRAM 335 memory elements. Similarly, the second FPGA 331 is connected to a dedicated second SRAM 336 and second SDRAM 337 memory elements. The first and second SRAM memory elements 334, 335 are each a single 512 kbyte part that is 16 bits wide and 256 k entries deep, but are logically separated into a global header storage area, an A memory element and a B memory element. The first and second FPGAs communicate over an FPGA bus 338. The FPGAs are encoded with a front-end tool using a PC running Microsoft's Windows 2000 operating system and applications from Synplicity including a VHDL language and the SynplifyPro compiler/synthesizer software package. A back-end tool includes Foundation software from Xilinx.

The LIM 323 eavesdrops on the ATM network in both the receive and transmit directions, parses the header 201 from the payload 202 of each cell 200, determines to which stream the cell belongs, determines if a particular stream is being tracked, obtains network performance data by counting events, calculating statistics or calculating error check products, such as a Cyclical Redundancy Check (“CRC”) product for the stream over a given period of time, and stores the network performance data into the SRAM 334 or 336 in one of the two logical parallel memory elements, memory element A 301 or memory element B 302. The SRAMs 334, 336 are 512 kbyte memories having an 18-bit address bus and a 16-bit data bus. Memory element A 301 comprises 128 kbytes of the SRAM 334 or 336 covered by addresses 00000-0FFFFhex. Memory element B 302 comprises 128 kbytes covered by addresses 10000-1FFFF hex. Addresses 20000-20007 hex store A and B copies of per channel cell counters and addresses 20008-2000D hex store A and B copies of per channel OAM/RM cell counters. The remaining portion of the SRAM 334, 336 holds global configuration information including LIM status information and reserved space for future use. The LLP 324 of the test device 107 then periodically reads and processes the stored network performance data for eventual display on the test device 107. Because there is a significant quantity of network performance data to collect, the SRAM 334, 336 that holds the stored data is large enough so that the sequential reading of either one of the logical memory elements 301 or 302 takes a finite and significant amount of time. The amount of time is significant because the time it takes to read the entire memory element 301, 302 is greater than the time within which new network performance data may be gathered, calculated as necessary, and made available for storage. Consequently, data for a current time slot must be written to one of the memory elements 301, 302 before all of the network performance data from the former time slot is retrieved. If network performance data for the former time slot is overwritten during the data retrieval process, then the retrieved data will not reflect a coherent result.

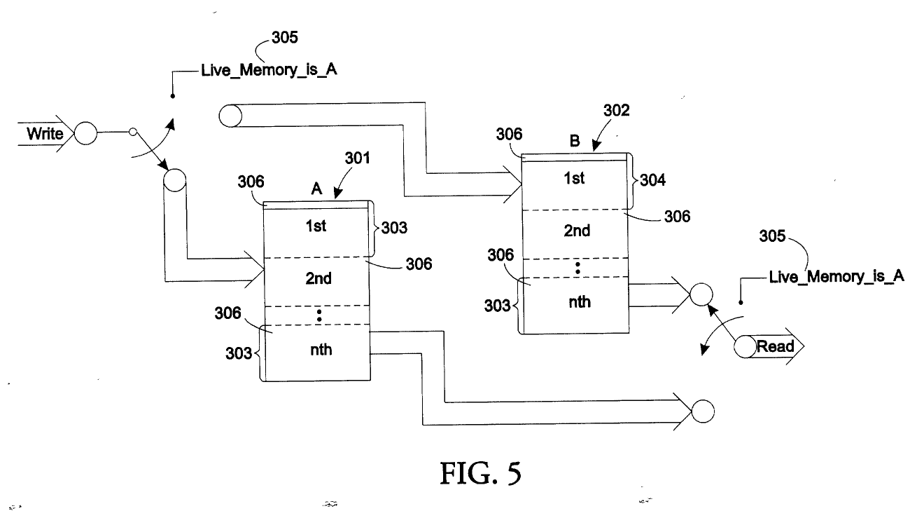

In order to achieve coherency among all of the statistics within a single time slot and with respect to FIG. 5 of the drawings, there is shown the logical A and B memory elements 301, 302 illustrated as separate and parallel entities The A and B memory elements 301, 302 are the same size and have parallellogical structures. In a specific embodiment, words of each memory element are assigned to contain the network performance data related to specific streams. Addresses 0 through 15 of the A memory element 301 comprise a first A data block 303. Addresses 0 through 15 of the B memory element 302 comprise a first B data block. Each first A and B data block contains 2 32-bit words of stream specific configuration information and 6 32-bit words representing different numbers of network performance data for stream #1. Because the A and B memory elements 301, 302 are parallel entities, corresponding entries for each memory element 301, 302 hold a number that represents the same piece of network performance data. Second A and B data blocks, represented by addresses 16 through 31 of respective first and second memory elements 301, 302, each contains the stream specific configuration information and six numbers of network performance data for stream #2. Third A and B data blocks, representing addresses 32 through 47 of the A and B memory elements 301, 302, respectively each contains stream specific configuration information and six different numbers of network performance data for stream #3, up to nth A and B data blocks containing stream specific configuration information and six different network performance data for stream #n. Each A and B data block 303, 304 has a starting address 306, which is the address of respective A and B memory elements for the first number of network performance data in the data block 303, 304. In the specific example, a pattern is established so that the stream number multiplied by 16 is equal to the starting address 306 of the stored network performance data for the stream pertaining to the stream number. As one of ordinary skill in the art can readily appreciate, there may be any number of network performance data entries for storage and provided the pattern is maintained, it is straightforward to obtain the starting address 306 from the stream number for the desired data block.

The A and B memory elements 301, 302 achieve a status of either “live” or “latched”. When one of the memory elements 301 or 302 has a “live” status, the other memory element 302 or 301 has a “latched” status. A live memory status bit 305 informs the system as to the status of the A and B memory elements 301. 302. In a specific embodiment, the live memory status bit 305 is a Live_memory_is_A bit meaning that a “1” value is interpreted to mean that the A memory 301 has a “live” status. Each memory element 301, 302 is either “live” or “latched”, but they have a different status from each other at all times. All network performance data is gathered and calculated over regular intervals. Each regular time interval is termed a time slot. During test, the test device 107 gathers network data and calculates statistics for the cells 200 and streams that are transmitted during a current time slot. The results of the calculations are stored into the “live” memory element 301 or 302. At the point in time that represents a transition from a current time slot to a next time slot, whichever memory element 301 or 302 that had the “live” status is converted to have the “latched” status. Results of the next time slot, therefore, are stored in a different memory element from the current time slot. The software level of the test device 107 retrieves the calculated network performance data for display on the test device 107. Working in conjunction with the hardware, the software initiates a read to the hardware from the memory element 301 or 302 having a “latched” status at the time the read is performed. While the read operation is retrieving all of the stored network performance data from the “latched” memory element 301 or 302, more network performance data is collected and calculated for the current time slot and are stored in the “live” memory element 302 or 301. The write and the read operations are mutually exclusive to each other for each memory element. Additionally, the write and the read operations are always performed on opposite memory elements. Advantageously, it is possible to continuously collect, calculate, store and display network performance data for a network running at-speed.

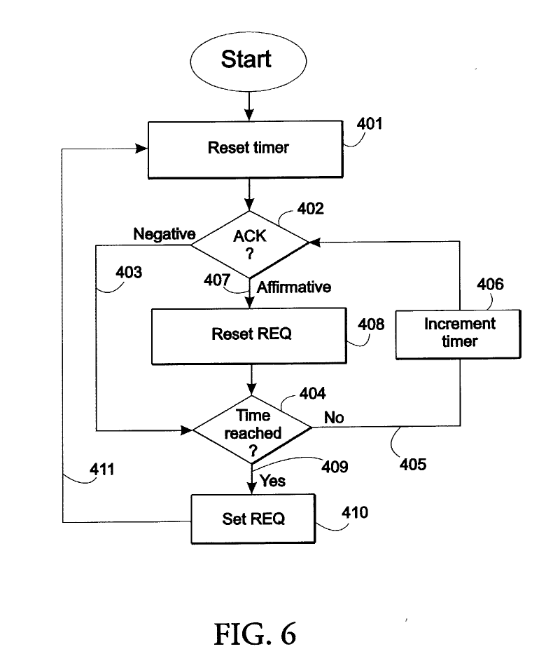

An embodiment of the system comprises three processes implemented in the FPGAs 330, 331 on the LIM 323. All three processes run concurrently. With specific reference to FIG. 6 of the drawings, there is shown a flow chart of a first process according to the teachings of the present invention for establishing a time slot within which network performance data are collected and calculated on data present on the network. A timer is reset 401 to a zero value. A loop first evaluates 402 an ACK flag. If the ACK flag is negative 403, the process then evaluates 404 the timer to determine if a time slot is complete. In a specific embodiment, the timer threshold is set to 1 second. Alternate embodiments, however, may have a register that permits a user to program a time slot value. If the time is not yet reached 405, the timer increments 406 and the loop repeats with the step of evaluating 402 the ACK flag. The timer increments 406 in accordance with a system clock, therefore all steps in the process are performed within a single system clock cycle. If the ACK flag is affirmative 407, a REQ bit is reset 408 to a zero value and then continues within the process with the step of evaluating 404 the timer to determine if the time slot is complete. If the time slot is complete 409, the REQ bit is set 410 and the process continues 411 with the step of resetting the timer 401. A specific embodiment of the process illustrated in FIG. 6 is implemented in hardware and each illustrated action box, i.e. 401, 406, 408 and 410, executes the described action within a single clock cycle while the decision diamonds, i.e. 402 and 404, occur immediately. As one of ordinary skill in the art can appreciate, the process illustrated in FIG. 4 of the drawings performs the function of incrementing the timer and measuring the time slot.

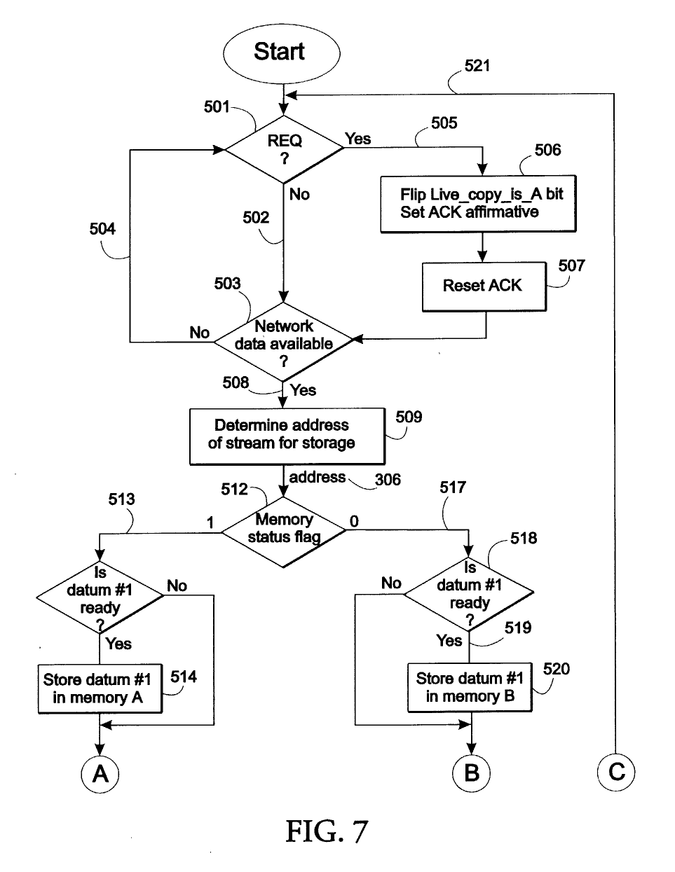

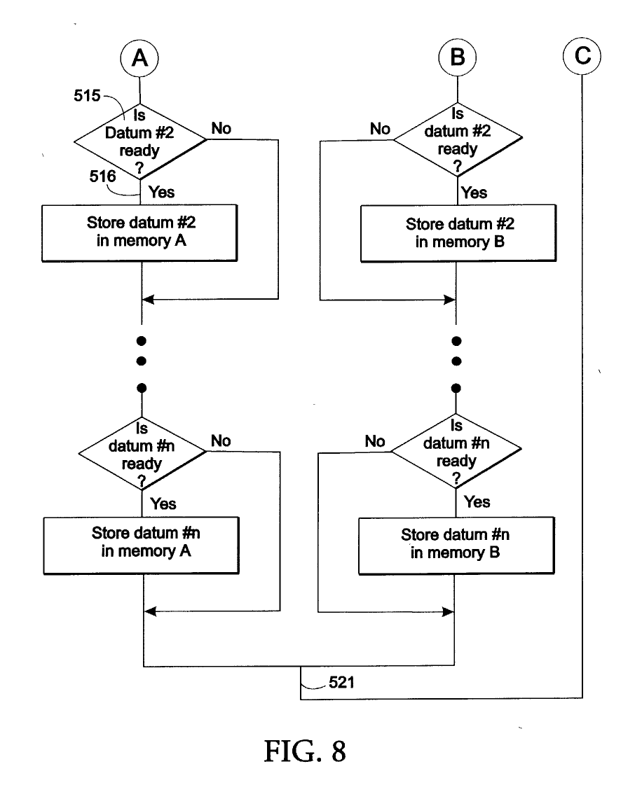

With specific reference to FIG. 7 of the drawings, there is shown a second process according to the teachings of the present invention in which network performance data are stored in the A or B memory element 301 or 302 upon completion of each time slot as measured in the process illustrated in FIG. 6 of the drawings. The process includes a loop that is triggered 501 by an affirmative REQ bit or if network performance data is available for storage in one of the memory elements 301, 302. When the REQ bit is affirmative 505, this signals that a time slot is complete, at which point the process toggles 506 the value of the live memory status bit 305 and sets 506 the ACK bit affirmative. The process of toggling and setting the live memory status bit 305 and the ACK bit occurs in a single clock cycle. The process then resets 507 the ACK bit in the next clock cycle before continuing. If the REQ bit is negative 502, no action is taken with respect to the live memory status bit 305. If network data is not yet available 504 the loop repeats at the step of evaluating the REQ bit 501 When data is available for storage 508, the process falls out of the loop. The process first determines 509 the starting address 306 of the data block 303, 304 in the A and B memory elements 301, 302 related to the stream under evaluation. In a specific embodiment, a content addressable memory (“CAM”) element is used to determine the starting address 306. When the system parses the cell, it obtains a stream identification number for the cell. The stream identification number is presented to the CAM and the CAM returns an address that contains the stream identification number. The CAM address multiplied by 16, or in the case of a hardware implementation a register shift of 4 bits, provides the starting address 306. Network performance data and related statistics for the cell and stream currently under evaluation are stored one number at a time in the A or B memory element 301, 302 beginning at the starting address 306. In a specific embodiment, the process attempts to store every datum in a serial process. The live memory flag 305 is then evaluated 512 to determine which memory element 301, 302 is to receive the network performance data. If the live memory flag 305 is affirmative 513, then the process then executes a series of steps to check and store the network performance data into the appropriate data block. Specifically, the process checks if a first datum is ready for storage and if so, stores 514 the first datum in the A memory element 301 at a location specified by the starting address 306. If the first datum is not yet ready, the storage step is skipped. With specific reference to FIG. 8 of the drawings, there is a continuation of the flow chart of FIG. 7 with continuity bubbles A, B, and C to show how the flow charts of FIGS. 7 and 8 connect. The process then checks if the second datum is ready for storage 515 and if so 516, stores the second datum in a next address in the data block after the starting address. Accordingly, if one or more of the data are not ready for storage, the storage step does not occur, but a step of incrementing an address for storage does occur. The process of checking if the datum is ready for storage and storing it if it is, and not storing if it is not, then incrementing to the next storage address continues until all of the network performance data for the cell and stream under evaluation is stored. If the live memory flag is negative 517, the process then checks 518 if the first datum is ready for storage, and if so 519, stores 520 the datum in the B memory element 302 at the starting address 306. The process continues in a serial process in the same way as described with respect to the A memory element until all available network performance data are stored. When the storage process is complete, the process returns 521 to the wait loop beginning with the step of evaluating the REQ bit 501.

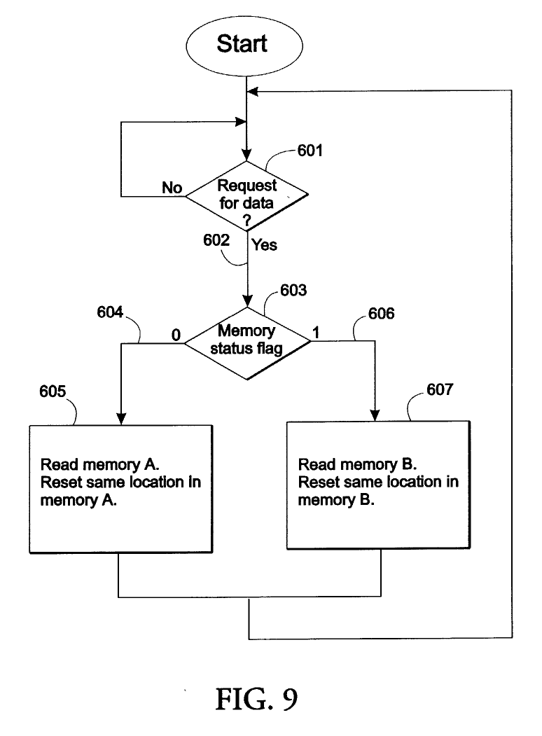

With specific reference to FIG. 9 of the drawings, there is shown a third process according to the teachings of the present invention in which the process waits in a loop until a request is made 601 to retrieve data from the A or B memory elements 301, 302. When the request is made 602, the process then evaluates 603 the value of the live memory flag 305. If the live memory flag 305 is negative 604, then the B memory 302 has a “live” status and the A memory 301 has a “latched” status. Accordingly, the requested data are retrieved 605 from the A memory 301 and the locations in the A memory 301 from which the data are retrieved are reset 605 to a zero value. If the live memory flag is affirmative 606, then the A memory 301 has a “live” status and the B memory 302 has a “latched” status. Accordingly, the requested data are retrieved 607 from the B memory 302 and the locations in the B memory 302 from which the network performance data are retrieved are reset 607 to a zero value. After the appropriate retrieval and reset steps, the process returns to the wait loop until another request for data is issued.

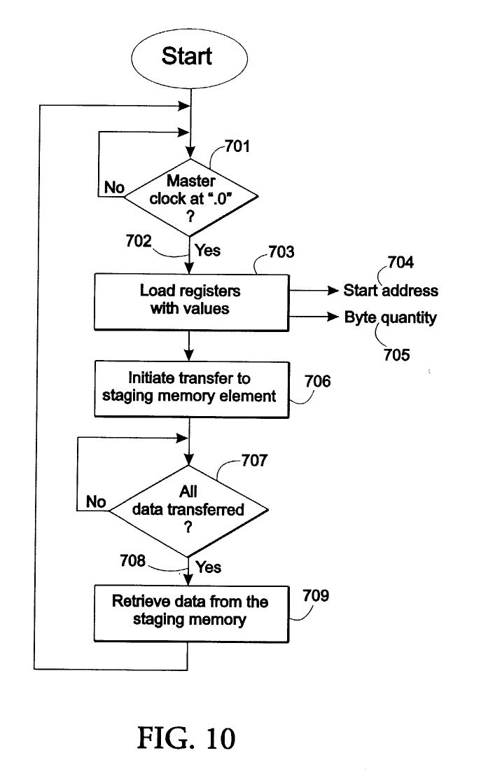

With specific reference to FIG. 10 of the drawings, there is shown a flow chart of a process that works in conjunction with the processes shown in FIGS. 6-9 of the drawings. In a specific embodiment, the process of FIG. 10 is implemented in software and performs the function of retrieving data from the A or B memory elements 301, 302 and displaying them to a user. Specifically, the process begins in a wait loop 701 where it evaluates a master clock for a “0.0” time. The “0.0” times are the points at which the master clock shows an integral number of elapsed seconds. At a next “0.0” time, the process exits 702 the wait loop and loads 703 a retrieval start address 704 and a quantity request 705 into two different hardware registers. The hardware recognizes the registers to contain the start address of the memory element 301 or 302 having a “latched” status at the time of data transfer and a quantity of data bytes that are to be transferred. The process then sends a signal to the hardware to initiate 706 the transfer of data from the A or B memory element 301, 302 to a staging memory element. The process waits 707 until all of the quantity of requested data bytes is transferred. The staging memory element is a memory element directly accessible by the software process. When the hardware signals that the transfer is complete, the process exits 708 the wait loop 707 and retrieves 709 the data from the staging memory. When the retrieval process is complete, the process returns to the wait loop 701 until the next “0.0” time of the master clock.

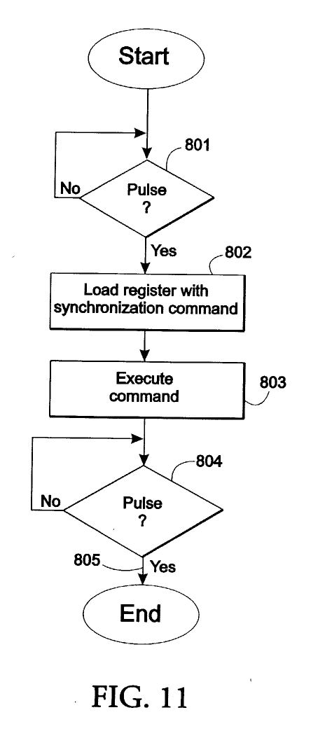

In a specific embodiment, the data is retrieved from the A or B memories 301, 302 every second. In a specific embodiment, the time interval for toggling the status of the A and B memory elements 301, 302 and the time interval for retrieval of the stored network performance data is the same. Alternate embodiments may retrieve data less often than data is stored as long as the hardware registers are sufficiently large so as not to overflow. In order for the hardware and the software processes to work in conjunction with each other, they are synchronized once at a beginning of the testing process. With specific reference to FIG. 11 of the drawings, there is shown a synchronization process, which is implemented in software in a specific embodiment, where the software communicates to the hardware. The system includes a master clock that provides a pulse every 100 msec. The synchronization process is executed once when a user pushes a START button on the tester. Just after the START button is actuated, the process first waits 801 for the next pulse of the master clock. When the pulse occurs, the software process writes a synchronization command into a register. The hardware immediately executes the command 803 once it is written into the proper register; at which point both the hardware and the software processes wait 804 for the next pulse of the master clock. When the next pulse of the master clock occurs 805, the software and the hardware processes identify that pulse as the mark or as T₀ time. Because both the hardware and the software operate against the pulses of the master clock, the processes remain synchronized.

Embodiments of the invention are described herein by way of example and are intended to be illustrative and not exclusive of all possible embodiments that will occur one of ordinary skill in the art with benefit of the present teachings. Specifically, a time slot may be defined as some other unit of time other than the one second, which is disclosed herein. The teachings may be applied to any data network, not just ATM, in which continuous and real time data collection is beneficial. Specifically, the teachings of the present invention may be applied to a transmission control protocol (“TCP”) by one of ordinary skill in the art. In a TCP embodiment, the “cell” is referred to in the industry as a “packet”. The method may be implemented in a different combination of hardware and software. In a specific embodiment the CAM and A and B memory elements are not part of the FPGA. As FPGAs become faster, larger and more cost-effective, it may become advantageous for the CAM and the A and B memories to become a part of the FPGA or for all of the logic and memory elements of the LIM to be implemented in a different technology that performs the same function. In a specific embodiment, the A and B memory elements are logical portions of the same memory. Alternatively, they may be two distinct memory chips.

1. A method of testing a network comprising the steps of:
parsing a cell from said network,
obtaining network performance data based upon said cell,
toggling a live memory flag at regular intervals of time,
evaluating a condition of said live memory flag,
storing said network performance data at said regular intervals of time in an A memory element if said live memory flag reflects an affirmative value,
storing said network performance data at said regular intervals of time in a B memory element if said live memory flag reflects a negative value, and
repeating said steps of parsing, obtaining, evaluating, and storing.

2. A method as recited in claim 1 wherein said step of obtaining network performance data further comprises calculating statistics based upon said network performance data.

3. A method as recited in claim 1 wherein said cell is an asynchronous transfer mode cell.

4. A method as recited in claim 1 wherein said cell is an transmission control protocol packet.

5. A method as recited in claim 1 and further comprising the steps of reading from said A memory if said live memory flag reflects a negative value, and reading from said A memory if said live memory flag reflects an affirmative value.

6. A method as recited in claim 5 wherein a timer marks a point in time when said network performance data is available from said A or B memory element.

7. A method as recited in claim 1 and implemented in hardware in a field programmable gate array (FPGA).

8. A method as recited in claim 1 wherein said regular intervals of time are programmable.

9. An apparatus for testing a network comprising:
means for parsing a cell on said network,
means for obtaining network performance data based upon said cell,
a live memory flag storage element,
means for toggling a value of said live memory flag storage element at regular intervals of time,
means for evaluating a condition of said live memory flag storage element,
an A memory element and a B memory element, wherein said A memory element receives said network performance data if said live memory flag storage element has an affirmative value and said B memory element receives said network performance data if said live memory flag storage element has a negative value.

10. An apparatus as recited in claim 9 and further comprising means for calculating statistics based upon said network performance data.

11. An apparatus as recited in claim 7 wherein said cell is an asynchronous transfer mode cell.

12. An apparatus as recited in claim 7 wherein said cell is an transmission control protocol packet.

13. An apparatus as recited in claim 9 and further comprising means for reading from said A memory element if said live memory flag storage element has a negative value, and reading from said B memory element if said live memory flag storage element has an affirmative value.

14. An apparatus as recited in claim 13 and further comprising a timer that marks a point in time when said network performance data is available from said A or B memory elements.

15. A apparatus as recited in claim 9 implemented in hardware in a field programmable gate array (FPGA).

16. An apparatus as recited in claim 9 and further comprising a time interval storage register, means for programming said time interval storage register, and means for comparing said time interval storage register against a timer that marks a point in time when said network performance data is available from said A or B memory elements.

17. A method of testing a network comprising the steps of:
eavesdropping onto said network,
parsing a cell from said network,
obtaining network performance data based upon said cell,
calculating statistics based upon said network performance data,
toggling a live memory flag at regular intervals of time,
evaluating a condition of said live memory flag,
storing said statistics at said regular intervals of time in an A memory element if said live memory flag reflects an affirmative value,
storing said statistics at said regular intervals of time in a B memory element if said live memory flag reflects a negative value,
retrieving said statistics at said regular intervals of time, and repeating said steps of parsing, obtaining, calculating, evaluating, storing, and retrieving.

18. A method as recited in claim 17 wherein said cell is an asynchronous transfer mode cell.

19. A method as recited in claim 17 wherein said cell is an transmission control protocol packet.

20. A method as recited in claim 17 and further comprising the steps of reading from said A memory if said live memory flag reflects a negative value, and reading from said B memory if said live memory flag reflects an affirmative value.
